(19) United States
(12) Patent Application Publication
(10) Pub. No.: US 2010/0188684 A1
(43) Pub. Date: Jul. 29, 2010

(54) METHOD AND SYSTEM FOR IDENTIFICATION OF SCANNING/TRANSFERRING OF CONFIDENTIAL DOCUMENT

(75) Inventor: Sampath Kumara, Bangalore (IN)

Correspondence Address: TUROCY & WATSON, LLP, 127 Public Square, 57th Floor, Key Tower, CLEVELAND, OH, 44114, US

(73) Assignees: KABUSHIKI KAISHA TOSHIBA, Tokyo (JP); TOSHIBA TEC KABUSHIKI KAISHA, Tokyo (JP)

(21) Appl. No.: 12/691,123

(22) Filed: Jan. 21, 2010

(30) Foreign Application Priority Data
Jan. 23, 2009 (IN) 153/CHE/2009

(51) Int. Cl. G06K 15/02

(52) U.S. Cl. 358/1.14; 358/474

(57) ABSTRACT

A method and system provided for identification of scanning/transferring of confidential documents using digital imaging devices, such as copiers, scanners printers fax machines and the like. When an imaging process is initiated, image of the document is send to a local OCR (scan) or remote server to perform OCR optical character recognition function. Thus converted document will be searched automatically by the system for keywords to determine the confidential nature of the document. In addition the device will store user details, process details (scan, copy, fax, email etc.), destination details etc., when processing of confidential documents occurs.

### CROSS-REFERENCE TO RELATED APPLICATION

This application is based upon and claims the benefit of priority from: India patent application No. 153/CHE/2009 filed on Jan. 23, 2009, the entire contents of which are incorporated herein by reference.

### TECHNICAL FIELD

This invention in general deals with document management in digital imaging devices, more particularly to a system and method for monitoring and controlling digital imaging processes with respect to the confidentiality of documents that are hard copied or send through wired or wireless communication protocols.

### BACKGROUND

Digital imaging devices that exist help users to scan, copy, e-mail and/or fax documents. Since these devices can be used by multiple users in a network, the security of confidential documents become great concern.

The securities of confidential documents are addressed by means of password protection, security codes, encoding etc. Also there are systems to store image and content of the document processed in the device along with the details of the user which will be in the form of Log files for retrieving audit trails. It will be a tedious job to search large volume of documents processed by the device in a large network for confidentiality breach.

It would be advantages if the digital imaging device or a remote server perform parallel search for keywords associated with a particular type of user (example: based on the designation of the user or level of the user, a set of key words will be specified to trigger the alert).

It would be advantage if a system can trigger alerts (preventive process) while the imaging process happens, hence reducing the storage space and also protects the confidential documents in real time.

Some of the prior art related to the invention mentioned here is referred below.

The United States Patent: U.S. Pat. No. 5,452,099 discloses Method and system for storage and/or transmission of confidential facsimile documents “Disclosed is a method and system for receiving and transmitting confidential documents and the like via facsimile machines. The system includes a security code-responsive, computer-controlled store and forward facility (SAFF) for receiving and transmitting documents between two remote facsimile machines. A security code is provided by the sender for each document transmission. The number does not identify a subscriber or a mailbox but identifies a fax message. Various degrees of security may be provided in sending a faxed document from a first location to a second location.”

The United States Patent: U.S. Pat. No. 5,579,392 discloses “Duplicating and ciphering device and methods for codification of facsimile telecopies. A duplicating and ciphering device in which, in order to retain the privacy of the document to be transmitted, the individual units of the duplicating and ciphering device are constructed as a duplicating machine, and annexation possibilities for an electronic memory for storing the information taken from the scanner and for a coding mechanism for coding this information. Such device can be used as a duplicating machine as well as a ciphering device for coding information before entering it into a fax machine. It is also suited to again emit incoming, encoded information in clear text. A method for coding facsimile telecopies is included whereby in sending, the original is scanned and transmitted line by line and at the receiving end a similar copy true to the original is printed out. In order to prevent confidential information from falling into the wrong hands, the content of the digital transmitted information is coded. A memory stores several dot rows and a coding mechanism.”

The United States Patent: U.S. Pat. No. 7,070,104 B2 discloses a scanable article having a signature section with alignment bars “An article scannable by a data capture device has an informational surface and a signature section disposed on the informational surface. The signature section has a signature area and at least two alignment bars A first alignment bar is disposed at a first end of the signature section relative to writing direction. A second alignment bar is disposed at the end of the signature section opposite the first end. The first and second alignment bars are within the signature section.”

The United States Patent: U.S. Pat. No. 6,342,954 B1 discloses “An image information processor has an image superimposing and outputting means for printing out a superimposed image where a bar code representative of a storage location of an electronic document file received through a facsimile is superimposed on the first page of the electronic document file. When a necessary electronic document file is read out, the bar code is read from the printed output corresponding to the necessary electronic document file being set by the user, the storage location of the electronic document file is decrypted from the bar code to thereby identify and read out the electronic document file. In this case, the reading of the bar code is performed only when a permitted password is inputted by the user. The readout of the electronic document file is not performed otherwise.”

The United States Patent: U.S. Pat. No. 5,001,750 discloses A secret communication control apparatus used to effect secret communication with communication equipment, for example, facsimile equipment, which transmits picture information by use of public communication lines. When a communication control code that is utilized to set a communication mode is to be transmitted, the intervention of the secret communication control apparatus in the communication is suspended by switching a change-over switch, so that the main body of the local communication equipment and the remote communication equipment perform direct transmission of the communication control code there between without passing it through the secret communication control apparatus. It is therefore possible to transmit the signal in the minimized time, that is, in the same way as in the case of ordinary, nonsecret communication.

The United States Patent: U.S. Pat. No. 7,099,023 B2 discloses A system and method have been provided for maintaining security in a network of imaging devices, such as copiers, scanners, printers, fax machines, and the like. In response to performing an imaging function, a copy of the document is sent to a security auditor for storage. In addition, other features such as user identification, the destination (if the document is sent), and the kind of imaging function performed (copy, print, send) can be stored and cross-referenced with the documents. The network can analyze the documents in storage for security purposes based upon factors such as user identification, document recipients, client number, and document subject matter, to name but a few.

The Multi Functional Peripheral (MFP) or Hard Copy Devices (HCD) are having the following major functionalities:

1. Scan and send the document using Network (to remote server. It can be e-Mail, FTP, News or any other).

2. Scan and Fax the document using Internet or PSTN Fax methods.

3. Scan and send the document using wireless network (communication with wireless servers, Hand Held devices, etc).

From the above points one can scan and send any data from MFP device to the external world. As the MFP is connected to the PSTN, LAN, Internet or Wireless network, how do we make this MFP an accountable for the vulnerability of the data from the Enterprise Network or from the users; In most of the case the Network is Secured, the desktop PC's are secured, the access to Servers are secured; but what's the kind of security we are providing the enterprise solution about the confidentiality of the data. Some of the MFP devices are logging each and every operations of the device on local data base; For example: user A has Scanned 10 Pages on 24 Jul. 2006, 10:32:30 AM, sent to user@disclosed.server; but here one doesn't know what kind of information he has exchanged also. In some of the MFP device they may also store the each and every incoming and outgoing document with the details of operation on the centralized server or on local hard disk of the devices.

There is no mechanism to detect that the user is scanning the company's confidential information and sharing with the other users. One can easily target on the MFP or HCD devices to leak the company's information without being known to others. There mechanisms to log the information events and the operations but not actually can identify the Company Confidential Documents.

### SUMMARY

According to an aspect of the present invention, there is provided a method for detection of scanning and/or transferring of confidential documents in digital imaging devices, the method comprising:

accepting the document at the device;

entering user identification code in the device with user interface;

assessing the security level associated with the user;

performing optical character recognition (OCR) operation on processed document based on the security level of the user;

keyword matching in converted document against predefined keyword database; triggering of alerts; and

Allowing/Denying selected digital imaging operation based on the configuration setting.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### DESCRIPTION OF THE DRAWINGS

The accompanying drawings, which are incorporated in and constitute a part of the specification, illustrate embodiments of the invention, and together with the general description given above and the detailed description of the embodiments given below, serve to explain the principles of the invention.

FIG. 1 is a schematic of a graphical user interface dialog box that can be implemented on a personal computer to control the device or the user interface dialog box that can be implemented on a device itself;

FIG. 2 is a schematic of a graphical user interface dialog box that can be implemented on a personal computer to control the device or the user interface dialog box that can be implemented on a device itself;

FIG. 3 is a schematic of a graphical user interface dialog box that can be implemented on a personal computer to control the device or the user interface dialog box that can be implemented on a device itself;

FIG. 4 is a schematic block diagram of a hardware and software components involved in this invention and the processing of the request; and

FIG. 5 is a schematic flow diagram of a scanning a document and identifying the document is “Confidential Document.”

### DETAILED DESCRIPTION

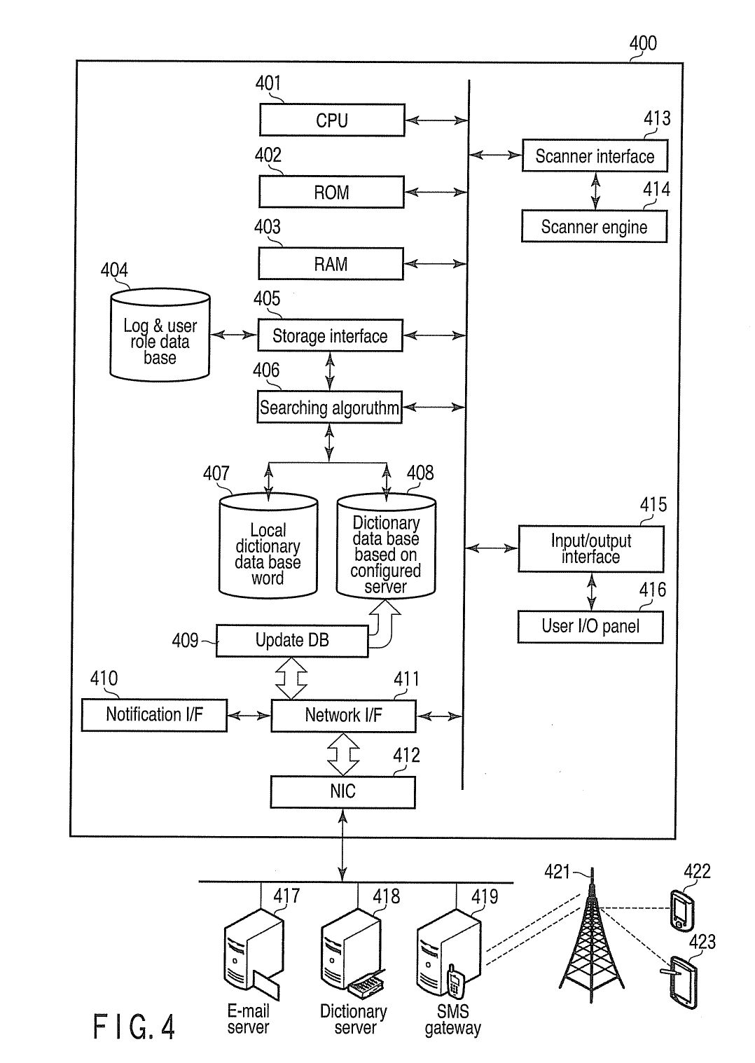

An embodiment of the present invention is explained in detail below with reference to the accompanying drawings. With reference to the accompanying figures, various embodiments of the invention including the FIG. 4 the block diagram of the entire system or the method used in this invention.

FIG. 4 is a schematic block diagram of a hardware and software components involved in this invention and the processing of the request.

In FIG. 4, the element (the system) 400 is a block diagram which provides a basic visualization of the hardware and the software components involved and their interactions. The element 400 process any request provided using UI element (Input/Output Interface) 415 received from and send to the user input/output panel 416 or from the Scanner interface element 413 connected with scanner engine 414 to the user provided request. These requests shall be forwarded to the respective software components in the system. The element (CPU) 401 shall process the request using the element (ROM) 402 and element (RAM) 403.

The system shall have the storage media where in the required “Confidential Dictionary Words” are stored in the storage media element (Log and User Role data base) 404, which can be accessed by the element (storage interface) 405.

The system shall have the element (Searching Algorithm) 406 for searching the “Confidential Dictionary Words” in the MFP data base element (Local dictionary data base (word)) 407 or the element (Dictionary data base based on Configured Server) 408.

The system shall have the element (NIC) 412 which provides the external communication to the LAN servers or the Internet servers. The element (network interface) 411 shall carry all the incoming and outgoing information for the network.

The system shall maintain 2 different data base as shown in FIG. 4 with the elements 407 and 408. The element 407 shall be a local confidential dictionary data base which shall contain all the “words” which are configured by the System Administrator. The element 408 contains all the confidential dictionary words data which are received from the external “Dictionary Server” element 418. The element (UPDATE data base) 409 shall update/synchronize the MFP dictionary data base which is configured. The proposed method in this invention shall either use any one of the data base in order to make sure that the scanned document doesn't contain the configured confidential document.

The system shall maintain the element (log data base) 404 where in the log information of the scanned document and the operations did for a given document shall be configured.

The system shall also maintain the element 404 where in the user information like user name and the corresponding role is maintained on the local data base of the MFP.

The system shall have the interface to the notification element (NOTIFICATION Interface) 410. This element shall notify to the corresponding notification servers or gateways 419 or 417 or e-mail server as configured by the system administrator. The mobile phone 422 or PDA 423 are connected NIC 412 via repeater 421 and SMS Gateway server 419.

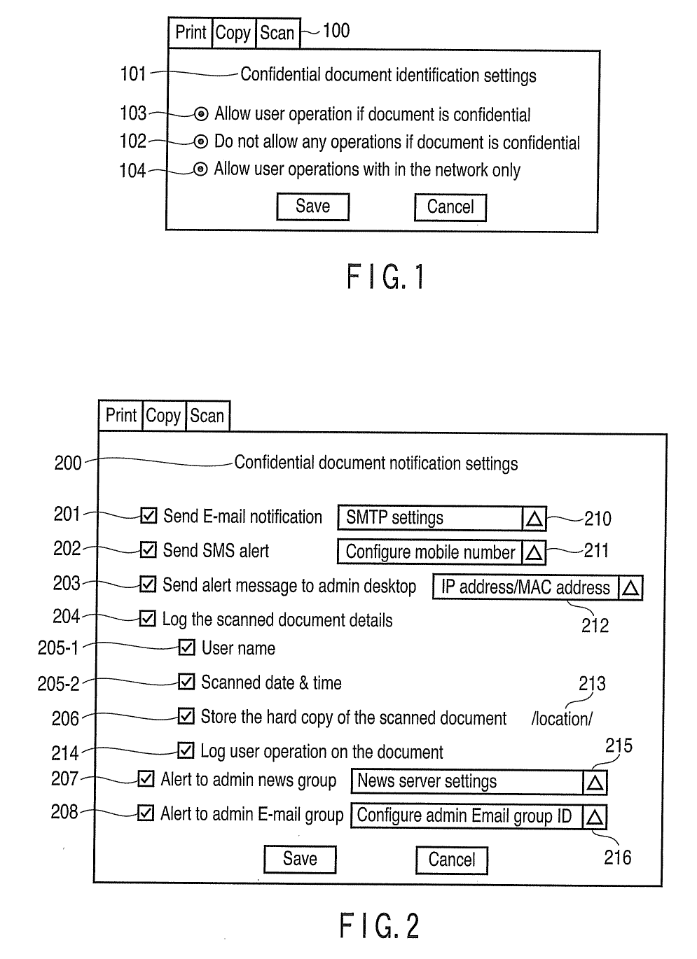

In particular referring to the user configuration of the system is shown in the FIGS. 1-3. The FIG. 1 shows the first level of “Confidential Document Identification Settings”. This is basically allows the system administrator to configure the action to be taken by the system when the scanned document found to be the confidential one.

In FIG. 1, the dialog box (element) 101 allows the admin to set the “Confidential Document Identification Settings” with scan (input) mode.

The element (check box) 103 allows the end user to scan the document and allows the user to do any operations on the scanned document with checking. If this option has been set in the UI configuration then the system shall maintain the logs of the operation and notifies according to the configured notification method. The element 103 can be used by the administrator when admin want to get the notification of the confidential document being scanned, in this option the end user can misuse the scanned document but the notification and logs are present for the audit purpose.

The element (check box) 102 doesn't allow the end use to do any operations on the scanned document, if the document found to be confidential document being scanned, the end user can't select any operations on the UI; all the UI related to the scanning operations shall be disabled so that the user can't take a copy or scan and send it to FTP server or e-Mail servers with checking.

The element (check box) 104 is similar to to the previous one but the operations are limited within the LAN, so that the scanned document can't be shared outside the organization network or in the internet with checking.

FIG. 2 shows the UI for setting the “confidential document notification settings”.

In FIG. 2, the dialog box allows the admin to set the different “Confidential Document Notification Settings”.

The element (dialog box) 200 shows the UI configuration of administrative settable configuration for different notification mechanism the admin prefers.

The element (check box) 201 and an element 210 can be configured by the admin if admin wants to receive the e-Mail notification if there are any documents being scanned which are of the Confidential ones with checking. By using the element 210 the admin can also configure the SMTP setting for sending the e-mails.

The element (check box) 202 and an element 211 provides the admin to configure the SMS notification mechanism where in he can configure the SMS gateway to receive the SMS from the MFP device.

The element (check box) 203 and an element 212 provides the admin to configure the notification messages shall be sent to the administrator desktop with in the LAN or to the group of admin desktops about the notifications.

The element (check box) 204 provides the admin to configure different logging parameters to be logged if the document being scanned one is the confidential. Some of elements (check boxes) shown are 205-1, 205-2, 206 and 214. By using these elements admin can configure the details of operations for the scanned document with checking.

The element (check box) 207 and an element 215 provides the admin to configure the alert message to the group of admin people in an organization using the news servers; the element (check box) 208 and an element 216 provides the alert messages using the group e-Mail ID.

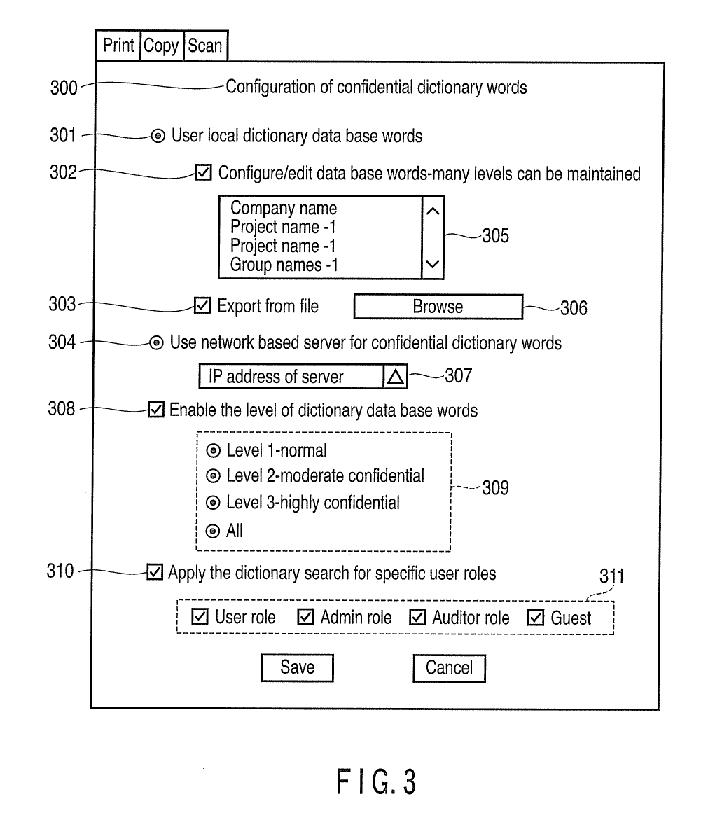

FIG. 3 shows the UI for setting the “Configuration of Confidential Dictionary Words” and other settings.

In FIG. 3, the dialog box allows the admin to set how the confidential words can be made and allows the user to set the different levels of the dictionary words for the device. The dialog also provides the option to apply the searching of confidential words for different roles present in the device.

The element (element) 300 is being broadly categorized into different sub sections of the UI configuration namely configuration of the confidential words, configuration of different levels and application for different roles defined in the given system.

The element (check box) 301 provides the option for the admin to decide whether to use the “local data base words” which was created on the MFP or already present in the MFP data base with checking.

The element (check box) 302 specifies how to add the new words the MFP local data base with checking. By having many elements like 302, the admin can have the option of creating the different levels of the confidential words. In order to use the element 301, the admin shall add/modify or delete the new words using the element 305 (linked with the element 302 and selectable). The admin can append the list words from a give file with an element (check box) 303; basically using the element (check box) 306 the list of words can be exported to the local MFP data base.

The element (check box) 304 provides the admin to select the “Dictionary Server” 418 from the local LAN or from the internet in order to update the MFP dictionary data base. When this option is set the MFP shall synchronize the data base with the server at the regular intervals. (Like every day or once a week or once in a month or every 12 hours which can also be configured by the admin).

The element (check box) 308 provides the admin to enable the different levels of dictionary data base search which are maintained locally or synchronized from the external server selected by server with the IP address set in (address) box 307. Basically the element (check box) 309 shows some of the level which can be maintained like normal mode, moderate and high confidential words.

If this option is selected when the user document shall be searched against the configured levels of the confidential words. The levels can be of any number; and admin can configure each of these levels by adding different words for these levels in the MFP.

The element (check box) 310 and an element (check box) 311 shall provide the admin to set the confidential word search for a specified role or for all the roles. These roles are purely based on the role system maintained on a specific MFP system. This option enables the admin to selectively check for the confidentiality of the document for the specified roles in the system. By using element 311 admin can select one or more roles to apply these settings.

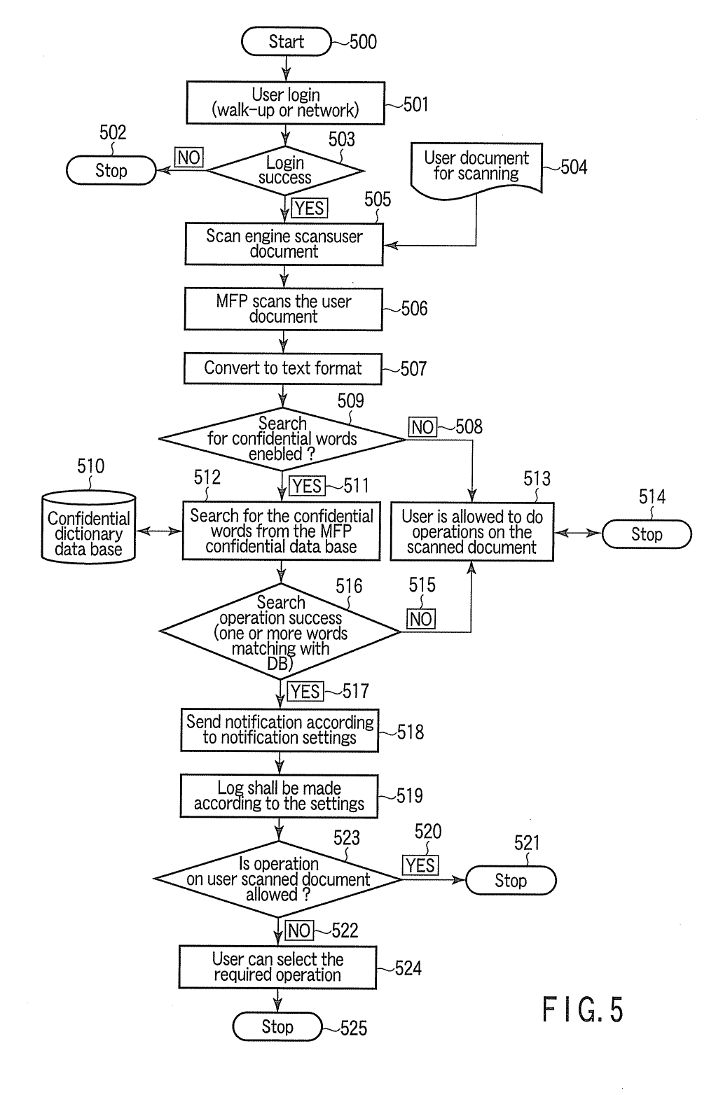

FIG. 5 represents the pictorial representation of processing the scanning and identification of the confidential words in the scanned documents by the user.

The detailed steps (500) are as follows:

Walk up user logins to the MFP, if the login failure then the user shall not be allowed to scan the document (act[501]).

If, the login success then the processing of the scanned document shall start (act[503]). If, the login is not success then all off steps are stopped (act[502]).

When the user document is scanned successfully (act[504], act[505] and act[506]), and then the document shall be converted to text format (act[507]). The details of element 507 are out of scope of this document. Once the document is converted to text format, the text shall be converted to words format.

Then later these words shall be searched (act[509]), and decides whether the searching is configured (act[511]) or not (act[508]); if confidentiality search is enabled (act[511] (YES)), then the search shall be executed; if search founds to be TRUE then there is a possibility that the document is a confidential document which belongs to the company proprietary information (act[512]).

After recognizing the document is confidential one with the Confidential dictionary data base 510 (act[516]), then shall send the notification to the administrator based on the notification settings done by the Admin (act[518]).

If there is any fail in the search (act[508] (NO)) or (act[515] (NO)), then the user shall be allowed to do any operations for the scanned document as shown in act[513], and then the operations are stopped (act[514]).

For the same event the log and if required a copy of the scanned document shall also be stored in the configured FTP server or in MFP storage location (act[519]).

Before allowing the user to do any operation on the scanned document the MFP shall” (act[523]). Accordingly the user operation shall be provided (act[520] (YES), the scan of Document is completed (act[521] (Stop)).

If admin set not to allow any operation (act[522] (NO)), then the scanned document shall not be sent outside or not even he can take a copy of the scanned document. Otherwise as mentioned in (act[524]), the user shall be allowed to do any kind of operations for the scanned document.

As disclose above, the HCD (hard Copy Devices) or MFP (Multi Function peripherals) is one of the basic elements of the Network, which will be used by all most all the users in the network. So there are possibilities that the one can use the MFP device to disclose the company's confidential data to the external world using MFP devices.

This invention is about finding the confidential data being scanned and sent outside the organization or company, which can be misused by other person or personnel. In this invention when ever a document is scanned for any purpose the scanned data will be captured and checks for the content of the Document. There will be a “Confidential Dictionary Words” in the

MFP device. When ever the document is scanned and checks for the content the content will be checked against whether any words are matching the “Confidential Dictionary Words”. If there is a match of the same, then the user will be notified on Control

Panel that you have scanned a “Company Confidential” document/information, do you want to continue with the operation.

Further, if the users accept to continue the operation then the “Notification Message” will be sent to the Administrator to indicate that the user has scanned and the operation of the “Confidential Document.”

The notification mechanisms can be using Desk top messages to Administrator, sending a Short Messages on his Mobiles/Pagers, an Email to Administrator Group ID, a log on local MFP device or a log on the remote device or information on FTP server or on news server, etc.

The notification mechanisms depend on the System Administrator configuration. If the user sends any confidential document the same document with the what operation the user has done can be stored in local MFP's hard disk or on the remote server.

The events/notifications, documents scanned and sent from MFP shall be used for the auditing or monitoring purpose, where in one can find where the entire document is distributed using MFP or HCD devices.

This invention also specifies the different configurations the system admin can set for the further operation on the “Confidential Document Settings.”

Do not allow any operation on the scanned document.

Allow the user even if the document is confidential.

Allow the user to do the operation on the scanned document within the network (LAN).

This invention also specifies the admin to configure the dictionary data base.

The data base can be configured either from Exporting from already existing file or admin can enter the words or the dictionary words can be retrieved from the configured server.

This invention also specifies the admin to configure how the notifications have been to be sent to the admin and its configuration. Also, the admin can configure different levels of the dictionary words which he can configure during set-up of the confidential data base for the MFP.

The admin can also apply the search criteria based on the dictionary words only for a specified roles defined in the MFP. Eg: Only Search for users with User Role or for users with Guest Role, etc.

The method also allowed automated keyword matching includes user or userlevel privilage based digital image processing, i.e., based on different user or userlevel, user will have privilage to perform digital imaging operation involving certain keywords which are specified in the remort keyword database.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A method for detection of scanning and/or transferring of confidential documents in digital imaging devices, the method comprising:
accepting the document at the device;
entering user identification code in the device user interface;
assessing the security level associated with the user;
performing optical character recongnition (OCR) operation on processed document based on the security level of the user;
automated keyword matching in converted document against predefined keyword database;
automated triggering of alerts; and
Allowing/Denying selected digital imaging operation based on the configuration setting.

2. The method of claim 1, wherein performing confidential document processing monitor can be disabled/enabled by the administrator.

3. The method of claim 2, wherein disabling/enabling can be done for any/all operations as shown in FIG. 1 for specific user/group of users based on the user privilage level.

4. The method of claim 1, wherein performing optical character recognition on processed document includes comparing user and user privilages specified in configuration setting to initiate OCR operation.

5. The method of claim 3, wherein performing optical character recognition includes partial processing of document or a predefined section of a document.

6. The method of claim 4, wherein the keyword database can be updated separately by administrator for each user or a group of users based on the user privileges.

7. The method of claim 1, where in automated trigering of alerts comprises of identification of configuration settings and selecting the mode of alert and escalation level.

8. The method of claim 6, wherein triggering of alerts include sending messages via sms, emails, or other electronic instrument which generate audio and/or visual alerts.

9. The method of claim 6, wherein escalation level can be updated by the administrator.

10. The method of claim 1, wherein Allowing/Denying will also lead to generating the audit trails in the server.

11. The method of claim 9, wherein generating audit trail as well as the server details can be specified by the administrator.

12. A system for detection of scanning and/or transferring of confidential documents in digital imaging devices, the system comprising:
accepting the document at the device;
entering user identification code in the device with user interface;
assessing the security level associated with the user;
performing optical character recognition (OCR) operation on processed document based on the security level of the user;
keyword matching in converted document against predefined keyword database;
triggering of alerts; and
Allowing/Denying selected digital imaging operation based on the configuration setting.

13. An imaging devices comprising:
a user interface which receives and sends to the user input/output panel;
an image reading interface which receives image read from an object to be read;
a local dictionary data base which stores dictionary data;
an UPDATE data base which stores dictionary data;
a log and user role base which stores log information of the scanned document and the operations did for a given document; and
a main control system which execute at least one of:
i) converted to text format “words” of the image scanned from the object;
ii) searched the “words” already converted from the object;
iii) recognizing the “words” is confidential one with a Confidential dictionary data base;
iv) checking a kind of settings are done by admin for a “Confidential Documents”; and
v) determining the scanned document not be sent outside or not even he can take a copy of the scanned.
